(19) United States
(12) Patent Application Publication
(10) Pub. No.: US 2005/0232190 A1
(43) Pub. Date: Oct. 20, 2005

(54) Sharing of user input devices and displays within a wireless network

(76) Inventors: Jeyhan Karaoguz, Irvine, CA (US); James D. Bennett, San Clemente, CA (US)

Correspondence Address: GARLICK HARRISON & MARKISON LLP, P.O. BOX 160727, AUSTIN, TX, 78716-0727, US

(21) Appl. No.: 11/153,163

(22) Filed: Jun. 15, 2005

Related U.S. Application Data
(63) Continuation-in-part of application No. 10/885,404, filed on Jul. 6, 2004.
(63) Continuation-in-part of application No. 10/885,405, filed on Jul. 6, 2004.
(60) Provisional application No. 60/504,752, filed on Sep. 22, 2003.
(60) Provisional application No. 60/505,276, filed on Sep. 23, 2003.
(60) Provisional application No. 60/504,869, filed on Sep. 22, 2003.
(60) Provisional application No. 60/649,883, filed on Feb. 3, 2005.

(51) Int. Cl. H04Q 7/20; H04Q 7/24; H04Q 7/00; G06F 15/16

(52) U.S. Cl. 370/328; 709/208; 455/425

(57) ABSTRACT

A subject wireless device having processing resources, a user input device, a display, and a wireless interface identifies a plurality of wirelessly networked devices that are wirelessly networked with the subject wireless device. The subject wireless device identifies at least one of a user input device and a display of the plurality of wirelessly networked devices that are available for use by the subject wireless device, selects from its native user input device and its native display and those user input devices and displays of plurality of wirelessly networked devices that are available. The subject wireless device receives user input via the selected user input device by the processing resources of the subject wireless device, processes the user input by the processing resources of the subject wireless device to produce an output, and displays the output on the selected display.

### CROSS REFERENCE TO RELATED APPLICATION

This application is a continuation in part of:
1. U.S. Utility patent application Ser. No. 10/885,404, filed Jul. 6, 2004, which claims priority to U.S. Provisional Patent Application Ser. No. 60/504,752, filed Sep. 22, 2003, both of which are incorporated herein by reference for all purposes;
2. U.S. Utility patent application Ser. No. 10/885,405, filed Jul. 6, 2004, which claims priority to U.S. Provisional Patent Application Ser. No. 60/505,276, filed Sep. 23, 2003, both of which are incorporated herein by reference for all purposes; and
3. U.S. Utility patent application Ser. No. 10/885,405, filed Jul. 6, 2004, which claims priority to U.S. Provisional Patent Application Ser. No. 60/504,869, filed Sep. 23, 2003, both of which are incorporated herein by reference for all purposes.

This application claims priority to U.S. Provisional Patent Application Ser. No. 60/649,883, filed Feb. 3, 2005, which is incorporated herein by reference for all purposes.

### BACKGROUND OF THE INVENTION

1. Field of the Invention

The present invention relates generally to wireless communications; and more particularly to operations supported by terminals that support wireless communications.

2. Description of Related Art

Communication systems are well known. Communication systems include both wired communication systems and wireless communication systems. Wired communication systems include the Public Switched Telephone Network (PSTN), Wide Area Networks (WANs), Local Area Networks (LANs), and other networks that use wired or optical media for the transmission of data. Wireless communication systems include cellular telephone systems, satellite communication systems, Wireless Wide Area Networks (WWANs), Wireless Local Area Networks (WLANs), Wireless Personal Area Networks (WPANs), and other networks that employ a wireless link between a serviced terminal and a network infrastructure or another wireless terminal. Of course, many communications are serviced using a combination of wireless communication systems and wired communication systems.

Wireless terminals were originally used to service only voice communications. However, wireless terminals now service data communications as well as voice communications. It is now common to use a wireless terminal to send and receive email, to send and receive text messages, and to access the Internet. With the advancement of technology, wireless terminals have become smaller, lighter, and more complex. Wireless terminals now typically have full reduced-size keyboards and displays that service complex video functions. While the processing resources and capabilities of the wireless terminals have increased, the ability of a user to interface with the wireless terminals has not. Reduced size keyboards are very difficult to use. Displays of the wireless terminals are now typically quite small in comparison to the size of a display of a personal computer, for example. Thus, setup and operation of the wireless terminals is often quite difficult using the reduced size keyboards and the small displays. Thus, there is a need in the art for a wireless terminal having improved interface that allows a user to more easily operate the wireless terminal.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a system diagram illustrating a wireless network that operates according to the present invention;

FIG. 2 is a flow chart illustrating operation according to an embodiment of the present invention;

FIG. 3A is a system diagram illustrating a particular example of operation according to an embodiment of the present invention;

FIG. 3B is a system diagram illustrating another particular example of operation according to an embodiment of the present invention;

FIG. 4 is a block diagram illustrating a display that operates according to an aspect of the present invention;

FIG. 5 is a block diagram illustrating components of the display of FIG. 4;

FIG. 6 is a block diagram illustrating a wireless terminal constructed according to the present invention; and

FIG. 7 is a block diagram illustrating a device that supports wireless communications and that operates according to the present invention.

### DETAILED DESCRIPTION OF THE INVENTION

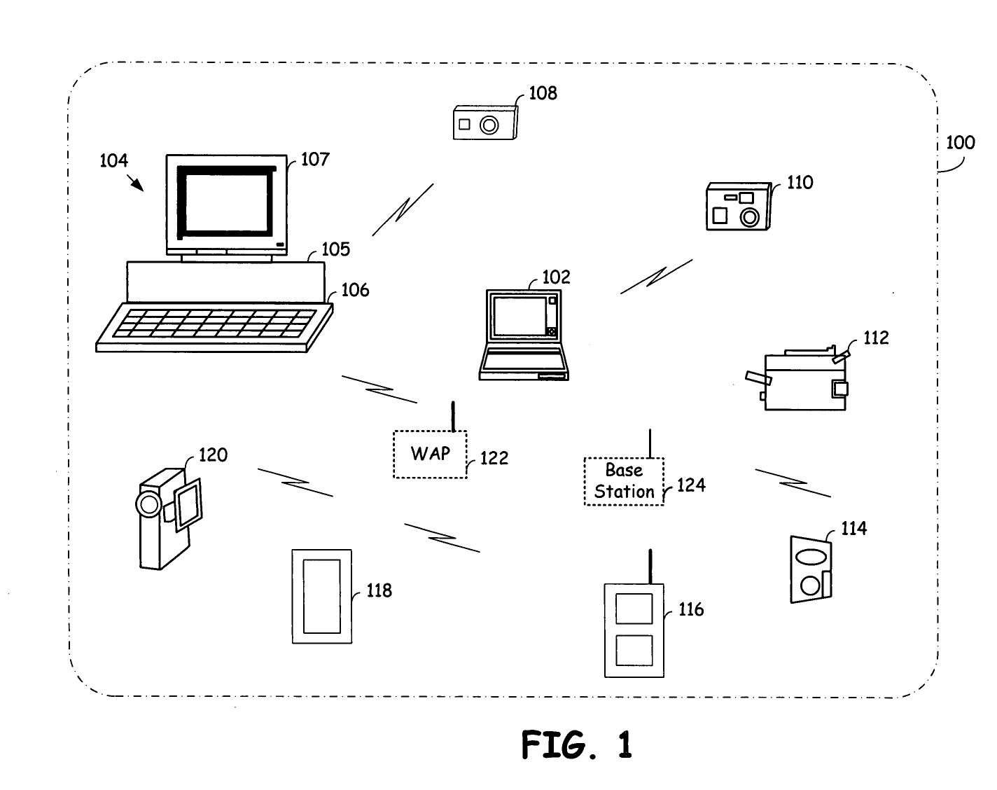

FIG. 1 is a system diagram illustrating a wireless network that operates according to the present invention. The wireless network 100 includes a plurality of devices that may be wirelessly networked and that are referred to hereinafter as a plurality of wirelessly networked devices. The plurality of wirelessly networked devices includes a laptop computer 102, a desktop computer 104, a projector 108, a digital camera 110, a printer 112, an MP3 player 114, a wireless telephone 116, a Personal Data Assistant (PDA) 118, and a camcorder 120. The wireless network 100 may be a Wireless Personal Area Network (WPAN), a Wireless Local Area Network (WLAN), a Wireless Metropolitan Area Network (WMAN), or a portion of a cellular wireless network. When the plurality of wirelessly networked devices 102-120 form a WPAN, the plurality of wirelessly networked devices 102-120 operate in a point-to-point communication scheme and support one or more of the Bluetooth operating standard, the IEEE 802.15 standard, or another WPAN operating standard. When the plurality of wirelessly networked devices 102-120 forms a WLAN, the plurality of wirelessly networked devices 102-120 support one or more WLAN standards such as the IEEE 802.11a standard, IEEE802.11b standard, IEEE802.11g standard, the IEEE802.11n standard, or another WLAN standard. When the wireless network 100 is a WLAN, it may include a Wireless Access Point (WAP) 122. However, WLAN communication protocols also support ad-hoc networking in which wireless devices communicate directly with one another and do not require the WAP 122. When the plurality of wirelessly networked devices 102-120 form a WMAN, the plurality of wirelessly networked devices 102-120 may support the IEEE802.16 standard, for example, and may include a base station 124 or WAP 122. When the plurality of wirelessly networked devices 102-120 support cellular wireless communications they communicate with a base station 124 and other infrastructure components. The cellular communications operate according to a cellular standard such as the 1xRTT, 1xEV-DO, 1xEV-DV, GSM, GPRS, EDGE, UMTS, or other communication standards. Each of the plurality of wireless devices 102-120 may support multiple communication standards and may support a plurality of WPAN, WLAN, WMAN, and cellular communications.

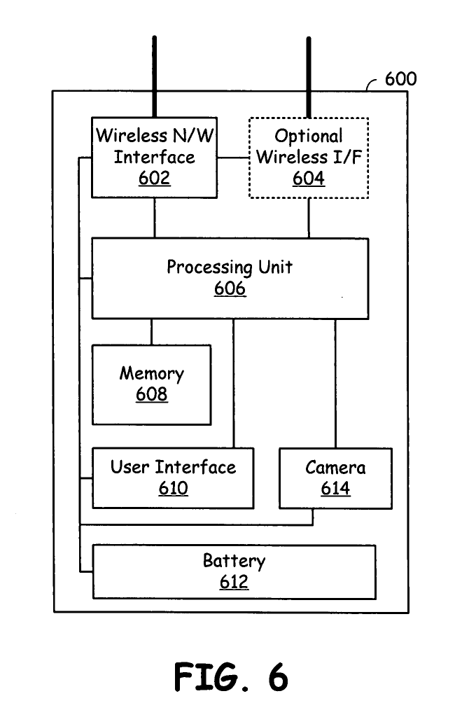

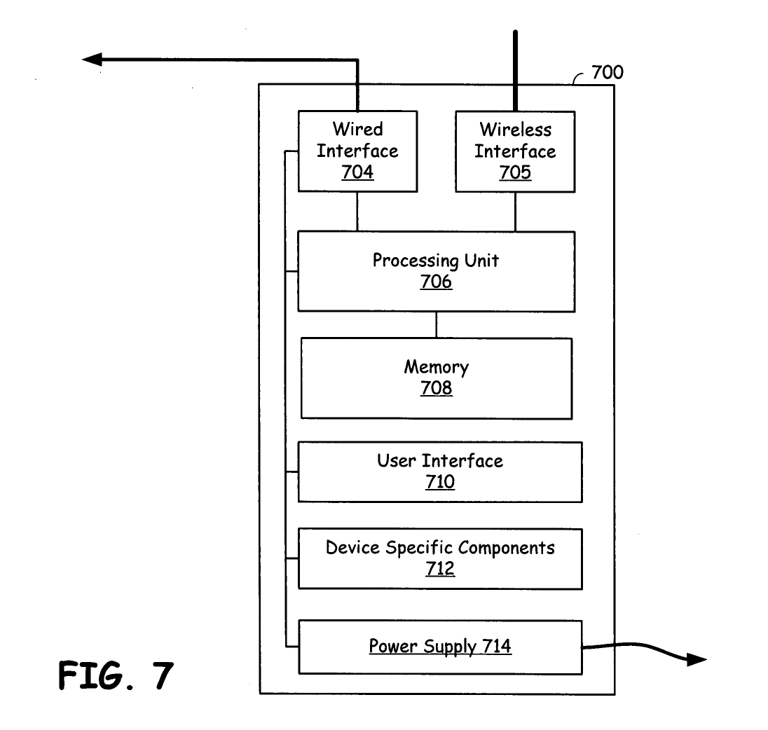

Each of the wireless devices 102-120 serviced within the wireless network 100 includes a user input device, a display, a wireless interface, and processing resources. The particular example of a handheld portable wireless device is illustrated further with reference to FIG. 6. Such handheld portable wireless device may be the digital camera 110, the MP3 player 114, the wireless telephone 116, the PDA 118, or the camcorder. The wireless telephone may be a cellular telephone, a WLAN telephone, a WPAN telephone, or another type of wireless telephone. The structure of the wireless devices that are at least relatively stationary in their normal operations, e.g., the laptop computer 102, the desktop computer 104, the projector 108, and the printer 112, are described further with reference to FIG. 7. The wireless devices illustrated in FIG. 1 may of course include additional or differing components than those that are illustrated in FIGS. 6 and 7.

Each of the plurality of wirelessly networked devices 102-120 of FIG. 1 includes at least one user input device, at least one display, processing resources, and at least one wireless interface. For example, the desktop computer 104 of FIG. 1 includes processing resources 105, a keyboard 106 that serves as a user input device 106, a monitor 107 that serves as a display, and a wireless interface (not shown in FIG. 1 but that is illustrated further in FIG. 7). Those components of the wireless devices directly contained within, physically appended to, or directly coupled to a device are referred to herein as “native” components. Thus, the keyboard 104, the processing resources 105, and the monitor 107 of the desktop computer are native to the desktop computer 104. Each of the other wirelessly networked devices 102 and 106-120 of FIG. 1 includes a wireless interface, at least one user input device, at least one display, and processing resources, each of which is native to a particular wirelessly networked device 102 and 106-120.

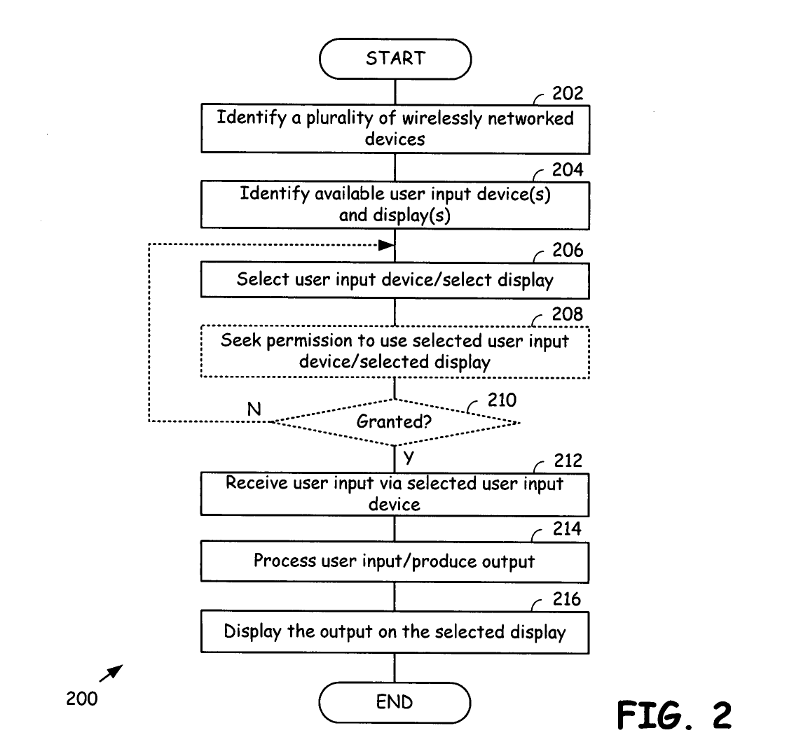

According to the present invention, the wireless interfaces of the wirelessly networked devices 102-120 support sharing of user input devices and displays among the plurality of wirelessly networked devices 102-120. The manner in which these devices 102-120 share their user input devices and displays is described further with reference to FIGS. 2-5. For example, the printer 112 may have a small display and a limited functionality user input device, e.g., a few buttons. According to the present invention, the printer 112 and laptop computer 102 operate so that user input is received via the keyboard and/or mouse of the laptop computer 102 to access the processing resources of the printer 112. Further, the display of the laptop computer 102 may be employed to display output produced by the processing resources of the printer 112.

FIG. 2 is a flow chart illustrating operation according to an embodiment of the present invention. A “subject wireless device,” referred to herein with reference to FIGS. 2 and subsequent figures may be any of the wirelessly enabled devices 102-120 of FIG. 1. Each of these wireless devices includes processing resource, one or more user input devices, one or more displays, and at least one wireless interface. Operation commences with the subject wireless device identifying a plurality of wirelessly networked devices that are wirelessly networked with the subject wireless device (Step 202). Then, for at least one of the plurality of wirelessly networked devices, the subject wireless device identifies at least one of a user input device and a display that are available for use by the subject wireless device (Step 204).

With one particular example of the operations of the embodiment of FIG. 2, the subject wireless device is the wireless telephone 116 of FIG. 1. The wireless telephone 116 includes at least one user input device, which may be a keypad, a tracking wheel, a mouse, one or more buttons, or voice activation, for example. The wireless telephone 116 includes a display, which may or may not be touch sensitive. When the display is touch sensitive it also serves as a user input device. The wireless telephone 116 includes a wireless interface and processing resources. One example of a structure of the wireless telephone 116 will be described further with reference to FIG. 6. The at least one other wirelessly network device of the present example includes one or more of the other wirelessly networked devices of FIG. 1, 102-114 and 118-120. Of these other wirelessly networked devices, the laptop computer 102 includes a keyboard (user input device), a mouse (user input device), and a monitor (display), among other components. The desktop computer 104 includes a keyboard 106 that is a user input device and a monitor 107 which is a display. The desktop computer 104 may also include a mouse, another cursor, or another user input device. These user input devices and displays may be available to the wireless telephone 116, which is the subject wireless device. Other user input devices that may be available for use with the wireless telephone 116 are a touch sensitive display of the PDA 118 and the buttons/cursors of the other devices. Other displays that may be available for use with the wireless telephone 116 are also the touch sensitive display of the PDA 118 and the displays of the other devices.

The operation of FIG. 2 continues with the subject wireless device selecting a user input device from the user input device of the subject wireless device and at least one user input device of the plurality of wirelessly network devices (Step 206). Thus, the subject wireless device, which is the wireless telephone 116 in the current example, may identify a keyboard of the laptop computer 102 and a keyboard 106 of the desktop computer 104 as being available as user input devices. With the present example, therefore, the operations at Step 206 would include selecting one of the user input device of the wireless telephone 116, the keyboard of the laptop computer 102, and the keyboard of the desktop computer 104. Further, at Step 206 base upon the present example, operation includes selecting a display from the display of the subject wireless device and at least one display of the plurality of wirelessly network devices (Step 208). In such case, the operations of Step 208 include selecting from the display of the wireless telephone 116, the display of the laptop computer 102, and the display 107 of the desktop computer 104. The selection of the display and also of the user input device may be made by the user of the subject wireless device. Such selection may be made base upon user input received at the native user input of the wireless telephone 116 or at a default user input device that is native to another of the plurality of wirelessly networked devices that is preauthorized to do so. Continuing with the present example, the keyboard 106 of the wireless computer 104 is selected as the user input device. Further, the monitor 107 of the desktop computer 104 is selected as the display. In a modification of this example, both the keyboard 106 of the desktop computer 104 device and a mouse (not shown) of the desktop computer 104 are selected.

Operation continues with the optional step of satisfying an authentication requirement in order to use a display or a user input device of a wirelessly network device (Step 208). Such operation may be password based, based upon defaults, or based upon another authentication or security mechanism (Step 208). When permission is granted, as determined at Step 210, operation proceeds to Step 212. However, when permission is not granted operation returns to Step 206 where the user is prompted to select either a differing user input device, a differing display, or both a differing user input device and a differing display.

At step 212, operation continues with receiving user input via the selected user input device by the processing resources of the subject wireless device (Step 212). Continuing with the previous example, the selected user input device is the keyboard 116 of the desktop computer 104. Processing resources of wireless telephone 116 therefore receive input from the keyboard 106 of the desktop computer 104 via the wireless interface of the desktop computer and the wireless interface of the wireless telephone 116. Of course, the user input may require passing through and/or processing of additional components of the desktop computer 104 and wireless telephone 116 as well. With the present example, the processing resources of the wireless telephone 116 receive user input via the keyboard 106 of the desktop computer.

Operation continues with the processing resources of the subject wireless device processing user input to produce an output (Step 214). Operation completes with the subject wireless device displaying the output on the selected display (Step 216). Continuing with the previous example, with the display 107 of the desktop computer 104 being the selected display, the processing resources of the wireless telephone 116 will cause the display to be output on the monitor 107 of the desktop computer 104. Such output will be prepared by the processing resources of the wireless telephone and will pass via at least the wireless interface of the wireless telephone 116 and the wireless interface of the desktop computer 104.

Thus, according to the present invention, a user of the wireless telephone 116 is not limited to using the native user input and native display of the wireless telephone 116 when using the wireless telephone. Instead, the user may select any of a number of user input devices and displays when operating the wireless telephone 116 and stimulating its processing resources. Thus, the user of the wireless telephone 116 may use other user input devices and displays when sending or receiving text messages, when setting up or configuring the wireless telephone 116, when accessing the Internet via the wireless telephone 116, when sending or receiving email via the wireless telephone 116, or when using the processing resources (and other resources) of the wireless telephone 116.

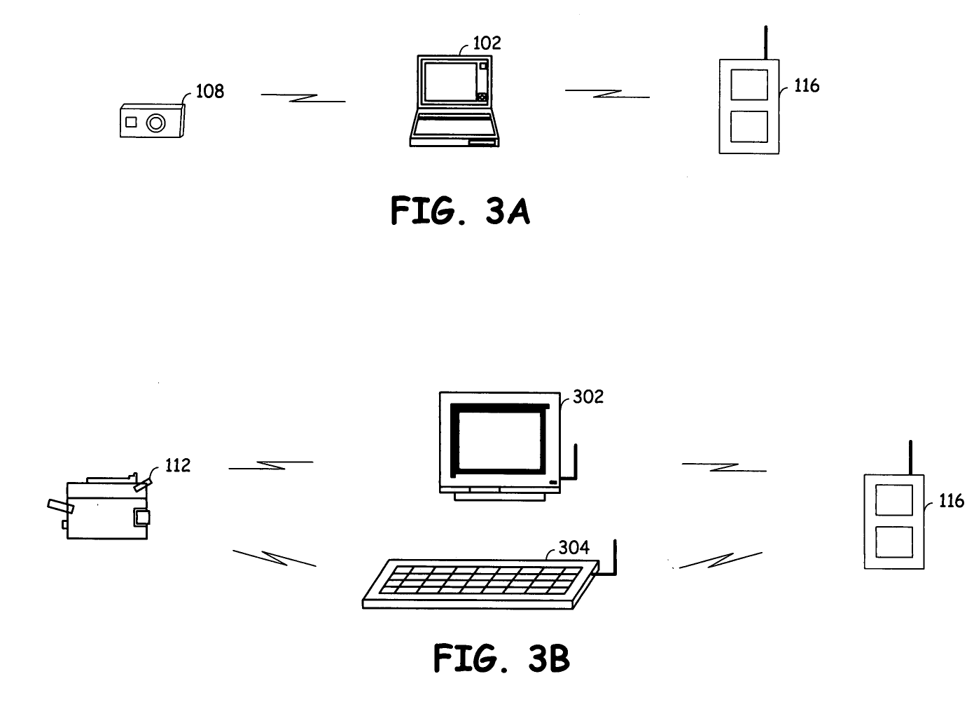

FIG. 3A is a system diagram illustrating a particular example of operation according to an embodiment of the present invention. In a first portion of the example of FIG. 3A, the subject wireless device is again the wireless telephone 116. In such case, the operation of the present invention is employed to use the user input device, i.e., keyboard of the laptop computer 102 as the input device for wireless telephone 116. In such case, a user of wireless telephone 116 may use the keyboard of the laptop computer 102 to input text messages that are sent via the wireless telephone 116. Alternatively, the user of the wireless telephone 116 may use the keyboard of the laptop computer 102 to perform setup operations for the wireless telephone 116. In such case, the display of the wireless telephone 116 may be used during these operations. Alternatively, the display of the laptop computer 102 may be employed for display of the output of the wireless telephone 116.

In another example illustrated with reference to FIG. 3A, the laptop computer 102 serves to provide input to projector 108 for the setup and operation of the projector 108. In such case however, the native output of the digital projector is selected for the subject wireless device the projector 108. As the reader will appreciate, the native display of by the projector 108 may be projected upon a wall to provide satisfactory output. In such case, the laptop computer would serve only as a user input device for the projector 108.

FIG. 3B is a system diagram illustrating another particular example of operation according to an embodiment of the present invention. The example of FIG. 3B supposes that a keyboard 304 is a wireless keyboard and that a monitor 302 is a wireless monitor, each providing standalone operations. In such case, the wireless keyboard 304 may be employed to serve as a user input device for wireless telephone 116 or for printer 112. Further, wireless display 302 may serve as the display for either wireless telephone 116 or for printer 112. Such usage of the wireless keyboard 304 or the wireless display 302 may be employed during the setup or normal operations of the wireless telephone 116 or of the printer 112.

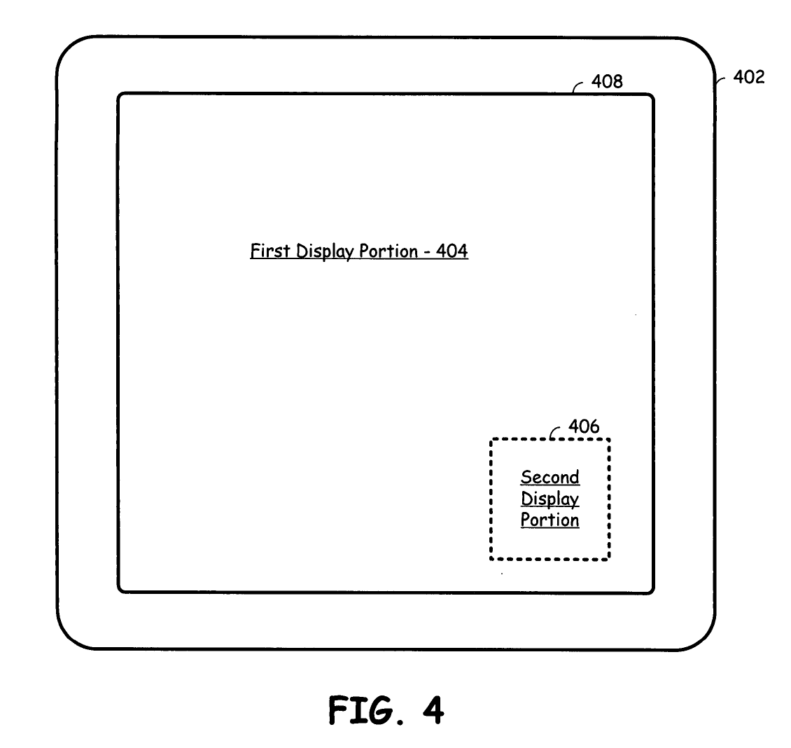

FIG. 4 is a block diagram illustrating a display that operates according to an aspect of the present invention. According to this aspect, a display 402 is sub-divided into a first display portion 404 and a second display portion 406 that together make up the complete display area 408 of the display 402. According to this aspect of the present invention, the output produced by the processing resources of a first wireless device are displayed on the first display portion 404. Further, output produced by the processing resources of a wirelessly network devices are displayed on the second display portion 406. These operations may be reversed in another aspect to the present invention.

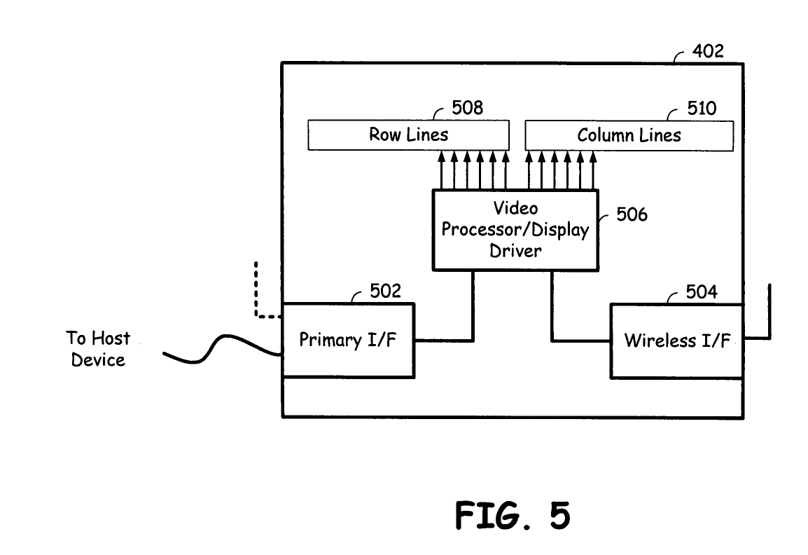

As will be further described with reference to FIG. 5, the display is subdivided so that it performs two distinct operations. In the first distinct operation, the first display portion 404 services the native processing resources associated with the display 402. For example, the display 107 of the desktop computer 104 may service both the processing resources 105 of the desktop computer and the processing resources of any other of the wirelessly network devices 102 or 108-120 of the wireless network 100. Thus, while the display 402 is performing its primary function for the desktop computer 104, it also performs a secondary function for a wirelessly networked device by displaying output produced by the wirelessly networked device on the second display portion 406.

FIG. 5 is a block diagram illustrating components of the display of FIG. 4. The wirelessly enabled display 402 includes a primary interface 404 that may be wired or wireless. The primary interface 404 couples the display 402 to its host device for which the display 402 serves as a native display. With the example of the desktop computer 104, the host device will be the processing resources 105 of the desktop computer. A typical interface may be one that is known in the art to be a parallel interface, a serial interface, or a high-speed wireless interface. A secondary wireless interface 406 services a wirelessly networked device 100 according to the present invention. Thus, continuing with an example as previously described, the wireless interface 406 may receive output from the wireless telephone 116. This output is received via the wireless interface 504, processed by processor/display driver 506, and displayed upon the second display portion 406 of the display 402. The video processor/display driver 506 combines the video information received via the primary interface 502 and the video information received from the wireless interface 504. The video processor/display driver 506 drives row lines 508 and column lines 510 to produce the first display portion 404 and the second display portion 406.

FIG. 6 is a block diagram illustrating a wireless terminal constructed according to the present invention. As shown in FIG. 6, the wireless terminal 600 includes a first wireless interface 602, an optional second wireless interface 604, a processing unit 606, memory 608, user interface 610, and a battery 612. The wireless terminal 600 may include a camera 614. The components of the wireless terminal 600 are typically contained within a hard case that provides protection from the elements. The wireless interface(s) 602 (and 604) will have particular structure and functionality based upon requirements of the wireless terminal 600. For example, when the wireless terminal 600 is a cellular telephone, the wireless interface 604 will support a corresponding interface standard. The wireless interface 602 of the wireless telephone 600 may also/alternately support WWAN, WLAN, and/or WPAN functionality. When the wireless terminal 600 serves as a WLAN terminal or WLAN telephone, for example, the wireless interface 602 or 604 will support standardized communication according to a WLAN interface standard. When the wireless terminal 600 serves as a WPAN device, the wireless interface 602 or 604 supports a WPAN interface standard. In any case, the wireless interface 604 may support all or a subset of cellular telephone, WLAN, WWAN, and WPAN operations.

The processing unit 606 may include any type of processor such as a microprocessor, a digital signal processor, an Application Specific Integrated Circuit (ASIC), or a combination of processing type devices. The processing unit 606 is operable to execute a plurality of software instructions that are stored in memory 608 and downloaded for execution. The processing unit 606 may also include specialized hardware required to implement particular aspects of the present invention. Memory 608 may include SRAM, DRAM, PROM, flash RAM, a hard disk drive, an optical media drive, or any other type of memory capable of storing data and instructions.

A user interface 610 may include a microphone, a speaker, a keypad, a screen, a touch screen, a cursor control device, a light, a voice recognition system, an optical recognition system that would authenticate a user's iris, for example, and/or any other type of interface that may be employed in the wireless terminal. In some embodiments, the user interface 610 may include therewith ability to service a headset including a microphone and an earpiece for the user. Battery 612 powers the components of the wireless terminal 600.

FIG. 7 is a block diagram illustrating a device that supports wireless communications and that operates according to the present invention. The wireless device 700 is intended for mostly stationary use and supports wireless communications. This device 700 includes both a wired interface 704 and a wireless interface 705. The wireless device 700 also includes a processing unit 706 (processing resources), memory 708, at least one user interface device 710, device specific component 712, and a power supply 714 that may receive input power from a wall outlet, for example. The device specific components 712 of the device 700 of FIG. 7 are specific to the intended function of the device 700. For example, when the device 700 is a printer, device specific component 712 would include those components required to have the device function as a printer. Likewise, when the device is a differing stationary device, the device specific component would include differing types of components.

As one of average skill in the art will appreciate, the term “substantially” or “approximately,” as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the terms “communicatively coupled” or “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled.” As one of average skill in the art will further appreciate, the term “compares favorably,” as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The invention disclosed herein is susceptible to various modifications and alternative forms. Specific embodiments therefore have been shown by way of example in the drawings and detailed description. It should be understood, however, that the drawings and description thereto are not intended to limit the invention to the particular form disclosed, but on the contrary, the invention is to cover all modifications, equivalents, and alternatives falling within the spirit and scope of the present invention as defined by the claims.

1. A method of operating a subject wireless device having processing resources, a user input device, a display, and a wireless interface, the method comprising:
identifying a plurality of wirelessly networked devices that are wirelessly networked with the subject wireless device;
for at least one of the plurality of wirelessly networked devices, identifying at least one of a user input device and a display that are available for use by the subject wireless device;
selecting a user input device from the user input device of the subject wireless device and at least one user input device of the plurality of wirelessly networked devices;
selecting a display from the display of the subject wireless device and at least one display of the plurality of wirelessly networked devices;
receiving user input via the selected user input device by the processing resources of the subject wireless device;
processing the user input by the processing resources of the subject wireless device to produce an output; and
displaying the output on the selected display.

2. The method of claim 1, wherein:
the selected user input device is native to a first wirelessly networked device of the plurality of wirelessly networked devices; and
the selected display is native to a second wirelessly networked device of the plurality of wirelessly networked devices.

3. The method of claim 1, wherein:
the selected user input device is native to the subject wireless device; and
the selected display is native to one of the plurality of wirelessly networked devices.

4. The method of claim 1, wherein:
the selected user input device is native to one of the plurality of wirelessly networked devices; and
the selected display is native to the subject wireless device.

5. The method of claim 1, wherein for at least one of the plurality of wirelessly networked devices, identifying at least one of a user input device and a display that are available for use by the subject wireless device further comprises satisfying an authentication requirement in order to use a display or a user input device of a wirelessly networked device.

6. A method of operating a subject wireless device having processing resources, a user input device, a display, and a wireless interface, the method comprising:
identifying a plurality of wirelessly networked devices that are wirelessly networked with the subject wireless device;
for at least one of the plurality of wirelessly networked devices, identifying a user input device that is available for use by the subject wireless device;
selecting a user input device from the user input device of the subject wireless device and at least one user input device of the plurality of wirelessly networked devices;
receiving user input via the selected user input device of a corresponding one of the plurality of wirelessly networked device by the processing resources of the subject wireless device;
processing the user input by the processing resources of the subject wireless device to produce an output; and
displaying the output on the display of the subject wireless device.

7. The method of claim 6, wherein receiving user input via the selected user input device of a corresponding one of the plurality of wirelessly networked device by the processing resources of the subject wireless device is also received via the wireless interface of the subject wireless device.

8. The method of claim 6, further comprising satisfying an authentication requirement in order to use a user input device of one of the plurality of wirelessly networked devices.

9. A method of operating a subject wireless device having processing resources, a user input device, a display, and a wireless interface, the method comprising:
identifying a plurality of wirelessly networked devices that are wirelessly networked with the subject wireless device;
for at least one of the plurality of wirelessly networked devices, identifying a display that is available for use by the subject wireless device;
selecting a display from at least one display of the plurality of wirelessly networked devices;
receiving user input via the user input device of the subject wireless device by the processing resources of the subject wireless device;
processing the user input by the processing resources of the subject wireless device to produce an output; and
displaying the output on the selected display of a corresponding one of the plurality of wirelessly networked devices.

10. The method of claim 9, wherein displaying the output on the selected display of a corresponding one of the plurality of wirelessly networked devices includes transmitting the output via the wireless interface from the subject wireless device to the corresponding one of the plurality of wirelessly networked devices.

11. The method of claim 9, further comprising satisfying an authentication requirement in order to use a display of one of the plurality of wirelessly networked devices.

12. The method of claim 9, further comprising:
subdividing the selected display into a first display portion and a second display portion;
displaying output produced by native processing resources of the wirelessly networked device on the first display portion; and
displaying the output produced by the processing resources of the subject wireless device on the second display portion.

13. A subject wireless device comprising:
a wireless interface;
a user interface including a user input device;
a display; and
a processing unit communicatively coupled to the wireless interface, the user interface, and the display and operable to:
identify a plurality of wirelessly networked devices that are wirelessly networked with the subject wireless device via th wireless interface;
for at least one of the plurality of wirelessly networked devices, identify at least one of a user input device and a display that are available for use by the subject wireless device;
select a user input device from the user input device of the subject wireless device and at least one user input device of the plurality of wirelessly networked devices;
select a display from the display of the subject wireless device and at least one display of the plurality of wirelessly networked devices;
receiving user input via the selected user input device by the processing resources of the subject wireless device;
processing the user input by the processing resources of the subject wireless device to produce an output; and
displaying the output on the selected display.

14. The subject wireless device of claim 13, wherein:
the selected user input device is native to a first wirelessly networked device of the plurality of wirelessly networked devices; and
the selected display is native to a second wirelessly networked device of the plurality of wirelessly networked devices.

15. The subject wireless device of claim 13, wherein:
the selected user input device is native to the subject wireless device; and
the selected display is native to one of the plurality of wirelessly networked devices.

16. The subject wireless device of claim 13, wherein:
the selected user input device is native to one of the plurality of wirelessly networked devices; and
the selected display is native to the subject wireless device.

17. The subject wireless device of claim 13, wherein the processing unit is further operable to satisfy an authentication requirement in order to use a display or a user input device of a wirelessly networked device.

18. A subject wireless device comprising:
a wireless interface;
a user interface including a user input device;
a display; and
a processing unit communicatively coupled to the wireless interface, the user interface, and the display and operable to:
identify a plurality of wirelessly networked devices that are wirelessly networked with the subject wireless device;
for at least one of the plurality of wirelessly networked devices, identify a user input device that is available for use by the subject wireless device;
select a user input device from the user input device of the subject wireless device and at least one user input device of the plurality of wirelessly networked devices;
receive user input via the selected user input device of a corresponding one of the plurality of wirelessly networked device by the processing resources of the subject wireless device;
process the user input by the processing resources of the subject wireless device to produce an output; and
display the output on the display of the subject wireless device.

19. The subject wireless device of claim 18, wherein the processing unit is further operable to satisfy an authentication requirement in order to use a display or a user input device of a wirelessly networked device.

20. A subject wireless device comprising:
a wireless interface;
a user interface including a user input device;
a display; and
a processing unit communicatively coupled to the wireless interface, the user interface, and the display and operable to:
identify a plurality of wirelessly networked devices that are wirelessly networked with the subject wireless device;
for at least one of the plurality of wirelessly networked devices, identify a display that is available for use by the subject wireless device;
select a display from at least one display of the plurality of wirelessly networked devices;
receive user input via the user input device of the subject wireless device by the processing resources of the subject wireless device;
process the user input by the processing resources of the subject wireless device to produce an output; and
display the output on the selected display of a corresponding one of the plurality of wirelessly networked devices.

21. The subject wireless device of claim 20, wherein the processing unit is further operable to satisfy an authentication requirement in order to use a display or a user input device of a wirelessly networked device.
